(19) United States
(12) Patent Application Publication
(10) Pub. No.: US 2020/0401873 A1
(43) Pub. Date: Dec. 24, 2020

(54) HARDWARE ARCHITECTURE AND PROCESSING METHOD FOR NEURAL NETWORK ACTIVATION FUNCTION

(71) Applicant: NEUCHIPS CORPORATION, Hsinchu (TW)

(72) Inventors: Youn-Long Lin, Hsinchu City (TW); Jian-Wen Chen, Hsinchu City (TW)

(73) Assignee: NEUCHIPS CORPORATION, Hsinchu (TW)

(21) Appl. No.: 16/558,314

(22) Filed: Sep. 3, 2019

(30) Foreign Application Priority Data
Jun. 19, 2019 (TW) 108121308

(51) Int. Cl. G06N 3/063; G06N 3/04

(52) U.S. Cl. CPC G06N 3/063; G06N 3/04

(57) ABSTRACT

A hardware architecture and a processing method for an activation function in a neural network are provided. A look-up table, which is a corresponding relation among multiple input ranges and linear functions, is provided. A difference between an initial value and an end value of the input range of each linear function is an exponentiation of base-2. These linear functions form a piecewise linear function to approximate the activation function. At least one bit value of an input value is used as an index to query the look-up table to determine a corresponding linear function. The part of bits value of the input value is fed into the determined linear function to obtain an output value. Accordingly, a range comparison may be omitted, and the number of bits of a multiplier-accumulator may be reduced, so as to achieve the objectives of low costs and low power consumption.

### CROSS-REFERENCE TO RELATED APPLICATION

This application claims the priority benefit of Taiwan application serial no. 108121308, filed on Jun. 19, 2019. The entirety of the above-mentioned patent application is hereby incorporated by reference herein and made a part of this specification.

### BACKGROUND OF THE DISCLOSURE

### Field of the Disclosure

The disclosure relates to a neural network technique, and more particularly, to a hardware architecture and a processing method thereof for an activation function in a neural network.

### Description of Related Art

The neural network is an important subject in artificial intelligence (AI) and makes decisions by simulating the operation of human brain cells. It is noted that there are many neurons in human brain cells, and these neurons are connected to each other through synapses. Each neuron may receive signals through the synapses, and transmits the signal after transformation to other neurons. The capability of transformation of each neuron is different, and human beings can form the capability of thinking and making decisions through the operation of the aforementioned signal transmission and transformation. The neural network achieves the corresponding capability based on the above operation.

FIG. 1 is a schematic view illustrating a basic operation of a neural network. Referring to FIG. 1, assuming that there are 64 neurons N₀ to N₆₃ in total and 32 input values A₀ to A₃₁, the input values are respectively multiplied by the corresponding weights W_{0,0} to W_{63,31} and the multiplied results are summed, and then added with biases B₀ to B₆₃, to obtain 64 output values X₀ to X₆₃. To avoid a linear decision result, the above operation results are eventually inputted to a non-linear activation function to obtain non-linear results Z₀ to Z₆₃. Common activation functions include tanh and sigmoid functions. The tanh function is (e^{x}−e^{-x})/(e^{x}+e^{-x}), and the sigmoid function is 1/(1+e^{-x}), where x is the input value. It is noted that non-linear functions often result in extremely high complexity in circuit implementation (especially, the division operation requires more hardware or software resources), which in turn affects the overall power consumption and processing efficiency. Accordingly, it is one of the objectives in the related fields to effectively solve the aforementioned issue caused by implementation of the activation function.

### SUMMARY OF THE DISCLOSURE

In view of the above, the disclosure provides a hardware architecture and a processing method thereof for an activation function in a neural network, in which a piecewise linear function is used to approximate the activation function to simplify the calculation, the input ranges are limited, and the bias of each piece of linear function is changed, to achieve a better balance between accuracy and complexity.

An embodiment of the disclosure provides a hardware architecture for an activation function in a neural network. The hardware architecture includes a storage device, a parameter determining circuit, and a multiplier-accumulator, but the disclosure is not limited thereto. The storage device is configured to record a look-up table. The look-up table is a corresponding relation among multiple input ranges and multiple linear functions, the look-up table stores slopes and biases of the linear functions, a difference between an initial value and an end value of each of the input ranges is an exponentiation of base-2, and the linear functions form a piecewise linear function to approximate the activation function for the neural network. The parameter determining circuit is coupled to the storage device and uses at least one bit value in an input value of the activation function as an index to query the look-up table, to determine the corresponding linear function. The index is an initial value of one of the input ranges. The multiplier-accumulator is coupled to the parameter determining circuit and calculates an output value of determined linear function by feeding a part of bits value of the input value.

On the other hand, an embodiment of the disclosure provides a processing method for an activation function in a neural network. The processing method includes the following steps, but the disclosure is not limited thereto. A look-up table is provided. The look-up table is a corresponding relation among multiple input ranges and multiple linear functions, the look-up table stores slopes and biases of the linear functions, a difference between an initial value and an end value of the input range of each of the linear functions is an exponentiation of base-2, and the linear functions form a piecewise linear function to approximate the activation function for the neural network. At least one bit value in an input value of the activation function is used as an index to query the look-up table, to determine the corresponding linear function. The index is an initial value of one of the input ranges. The output value of the determined linear function is calculated by feeding the part of bits value of the input value.

Based on the above, the hardware architecture and the processing method thereof for an activation function in a neural network are depicted in the embodiments of the disclosure. The piecewise linear function is used to approximate the activation function, the range size of each piece of range is limited, and the bias of each linear function is adjusted. Therefore, it is not required to perform multi-range comparison (i.e., a large number of comparators may be omitted), and the hardware operation efficiency can be improved. In addition, by modifying the bias of the linear function, the number of input bits of the multiplier-accumulator can be reduced, and the objectives of low costs and low power consumption can be achieved.

To make the aforementioned more comprehensible, several embodiments accompanied with drawings are described in detail as follows.

### BRIEF DESCRIPTION OF THE DRAWINGS

FIG. 1 is a schematic view illustrating a basic operation of a neural network.

FIG. 2 is a schematic view illustrating a hardware architecture for an activation function in a neural network according to an embodiment of the disclosure.

FIG. 3 is a schematic view illustrating a processing method for an activation function according to an embodiment of the disclosure.

FIG. 4 is a diagram illustrating a piecewise linear function approximating an activation function according to an embodiment of the disclosure.

FIG. 5 is a schematic diagram illustrating a piecewise linear function according to another embodiment of the disclosure.

### DESCRIPTION OF THE EMBODIMENTS

FIG. 2 is a schematic view illustrating a hardware architecture 100 for an activation function in a neural network according to an embodiment of the disclosure. Referring to FIG. 2, the hardware architecture 100 includes, but not limited to, a storage device 110, a parameter determining circuit 130, and a multiplier-accumulator 150. The hardware architecture 100 may be implemented in various processing circuits such as a micro control unit (MCU), a computing unit (CU), a processing element (PE), a system on chip (SoC), or an integrated circuit (IC), or in a stand-alone computer system (e.g., a desktop computer, a laptop computer, a server, a mobile phone, a tablet computer, etc.). It is noted that the hardware architecture 100 of the present embodiment of the disclosure may be used to implement the operation processing of an activation function of the neural network, and the details thereof will be described in the subsequent embodiments.

The storage device 110 may be a fixed or movable random access memory (RAM), read-only memory (ROM), flash memory, register, combinational circuit, or a combination of the above devices. In the present embodiment of the disclosure, the storage device 110 records a look-up table. The look-up table relates to a corresponding relation among input ranges and approximating linear functions of the activation function. The look-up table stores the slopes and biases of multiple linear functions, and the details thereof will be described in the subsequent embodiments.

The parameter determining circuit 130 is coupled to the storage device 110. The parameter determining circuit 130 may be a specific functional unit, a logic circuit, a microcontroller, or a processor of various types.

The multiplier-accumulator 150 is coupled to the storage device 110 and the parameter determining circuit 130. The multiplier-accumulator 150 may be a specific circuit capable of multiplication and addition operations, or may be a circuit or processor composed of one or more multipliers and adders.

To facilitate the understanding of the operation process of the present embodiment of the disclosure, several embodiments will be provided below to detail the operation process of the hardware architecture 100 in the present embodiment of the disclosure. Hereinafter, the method of the present embodiment of the disclosure will be described with reference to the devices or circuits in the hardware architecture 100. The processes of the method may be adjusted according to the implementation condition, and the disclosure is not limited thereto.

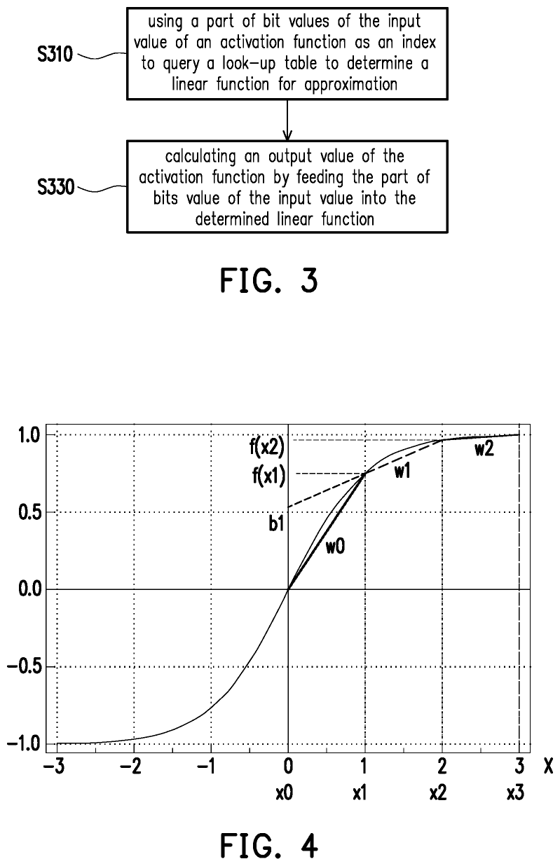

FIG. 3 is a schematic view illustrating a processing method for the activation function in the neural network according to an embodiment of the disclosure. Referring to FIG. 3, the parameter determining circuit 130 obtains an input value of the activation function and uses a part of bits value in the input value as an index to query the look-up table, to determine a linear function for approximating the activation function (step S310). Specifically, non-linear functions such as tanh and sigmoid functions commonly used as the activation function have an issue of high complexity in circuit implementation. In order to reduce the complexity, a piecewise linear function is adopted in the present embodiment of the disclosure to approximate the activation function.

FIG. 4 is a diagram illustrating a piecewise linear function approximating an activation function according to an embodiment of the disclosure. Referring to FIG. 4, the activation function is a tanh function, for example (i.e., ƒ(x)=tanh(x), where x is the input value, and ƒ( ) is the function). It is assumed that the range size of each input range is 1. For example, 0 to 1 is an input range, 1 to 2 is another input range, and so on. The tanh function may be approximated by a piecewise linear function ƒ1(x):

$$f 1 ( x ) = \{ \begin{matrix}{w}_{0} * x + {b}_{0} , & if {x}_{0} \leq x < {x}_{1} \\ {w}_{1} * x + {b}_{1} , & if {x}_{1} \leq x < {x}_{2} \\ {w}_{2} * x + {b}_{2} , & if {x}_{2} \leq x < {x}_{3} \\ 1 , & if {x}_{3} \leq x\end{matrix} \qquad ( 1 )$$

where x₀ to x₃ are the initial values or end values of the input ranges, x₀ is 0, x₁ is 1, x₂ is 2, and x₃ is 3. In addition, w₀ to w₂ are respectively the slopes of the linear functions of each of input ranges, and b₀ to b₂ are respectively the biases (or referred to as the y-intercept, i.e., the y-coordinate of the graph of this function intersecting with the y-axis (the vertical axis in FIG. 4)) of the linear functions of each of input ranges. The piecewise linear function ƒ1(x) intersects with the activation function ƒ(x) at the initial value and the end value of each input range. In other words, the result obtained by substituting the initial value or the end value of each input range into the belonged linear function is the same as the result obtained by substituting it into the activation function. The value of each slope is obtained by dividing a first difference by a second difference. The first difference is the difference between the results obtained by substituting the initial value and the end value of the input range into the activation function ƒ(x) or the belonged linear function ƒ1(x). The second difference is the difference between the initial value and the end value:

wᵢ=(ƒ(xᵢ₊₁)−ƒ(xᵢ))/(xᵢ₊₁−xᵢ) (2)

where i is 0, 1, or 2. In addition, the value of each bias is the difference between the result obtained by substituting the initial value of the input range into the activation function ƒ(x) and the product of the initial value and the corresponding slope:

bᵢ=ƒ(xᵢ)−wᵢ*xᵢ (3)

It is noted that the initial value of the input range is the same as the end value of the adjacent input range. The term “adjacent” here may also mean “closest”.

It is noted that the circuit design for implementing the piecewise linear function in the related art requires multiple comparators to sequentially compare the input value with the input ranges in order to determine the input range in which the input value is located. As the input ranges increase, more pieces of linear functions approximate the activation function, and a higher accuracy is obtained. However, the number of comparators also needs to be increased correspondingly, which increases the complexity of the hardware architecture. In addition, to avoid loss of accuracy, the multiplier-accumulator with a greater number of input bits is generally used, which similarly increases the hardware cost or even affects the operation efficiency and increases the power consumption. Although decreasing the input ranges or using a multiplier-accumulator with a small number of input bits can improve the aforementioned issue, doing so will result in loss of accuracy. Therefore, how to strike a balance between the two objectives of a high accuracy and a low complexity is one of the subjects requiring effort in the related fields.

The present embodiment of the disclosure provides a new linear function segmentation method, which limits the difference between the initial value and the end value of each input range to an exponentiation of base-2. For example, if the initial value is 0 and the end value is 0.5, then the difference between the two is 2\hat{ }−1; if the initial value is 1 and the end value is 3, then the difference between the two is 2\hat{ }1. When the input value is represented in the binary system, by using only one or more bits value in the input value as the index, the input range in which the input value is located may be determined without comparing any input ranges.

In addition, the look-up table provided in the present embodiment of the disclosure is a corresponding relation among multiple input ranges and multiple linear functions, and one input range corresponds to a specific linear function. For example, the input range is 0≤x<1 and corresponds to w₀*x+b₀, i.e., the linear function corresponding to one piece in the piecewise linear function. It is noted that the aforementioned index can correspond to the initial value of the input range. Since the range size (i.e., the difference between the initial value and the end value) of the input range is limited to the exponentiation of base-2, and the input value is represented in the binary system, the input range to which the input value belongs can be directly obtained from the bits value of the input value. Moreover, the index is also used to access the slope and bias of the linear function in the look-up table.

In an embodiment, the index includes the first N bits value in the input value, and N is a positive integer greater than or equal to 1 and corresponds to the initial value of the input range of one linear function. Taking FIG. 4 as an example, the range size of each input range is 2\hat{ }0, and the bits value before the decimal point of the input value may be used as the index. For example, if the input value is 0010.10102, then the bit value of two or more bits before the decimal point may be obtained as 102 (i.e., 2 in the decimal system) and correspond to the input range of x₂ x<x₃ in FIG. 4. In other words, the parameter determining circuit 130 only needs to query the look-up table by only using the part of bits value of the input value as the index, and then determines the input range to which the input value belongs and further determines the linear function to which the input value belongs. Therefore, in the present embodiment of the disclosure, the input ranges to which the input value belongs can be obtained through a simple and fast table lookup method, and it is not required to sequentially compare multiple input ranges through multiple comparators.

It is noted that “first” as in the aforementioned “first N” refers to the value of the N highest-order bits in the input value of the binary system. In addition, depending on different design variations of the input ranges, in other embodiments, the parameter determining circuit 130 may select the bit value of specific bits from the input value. For example, if the input ranges are 0≤x<0.25, 0.25≤x<0.75, and 0.75≤x<2.75, then the parameter determining circuit 130 selects the 1^{st} bit before the decimal point and the 1^{st} and 2^{nd} bits after the decimal point from the input value.

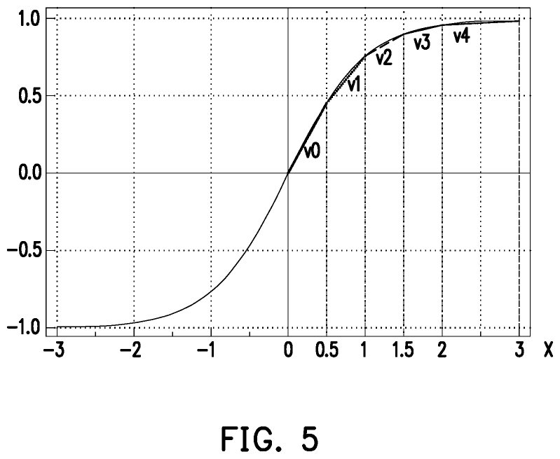

Other variations of the input ranges are also possible. FIG. 5 is a schematic diagram illustrating a piecewise linear function according to another embodiment of the disclosure. Referring to FIG. 5, the activation function is the tanh function, for example, and is approximated by a five-piece linear function ƒ2(x):

$$f 2 ( x ) = \{ \begin{matrix}{v}_{0} * x + {c}_{0} , & if 0 \leq x < 0.5 \\ {v}_{1} * x + {c}_{1} , & if 0.5 \leq x < 1 \\ {v}_{2} * x + {c}_{2} , & if 1 \leq x < 1.5 \\ {v}_{3} * x + {c}_{3} , & if 1.5 \leq x < 2 \\ {v}_{4} * x + {c}_{4} , & if 2 \leq x < 3 \\ 1 , & if 3 \leq x\end{matrix} \qquad ( 4 )$$

The differences between the initial value and the end value in each of the input ranges are respectively 2\hat{ }−1, 2\hat{ }−1, 2\hat{ }−1, 2\hat{ }−1, and 2\hat{ }0 (i.e., are all the exponentiation of base-2). v₀ to v₄ are respectively the slopes of the linear functions of the input ranges of each of the pieces, and c₀ to c₄ are the biases of the linear functions of the input ranges of each of the pieces. The piecewise linear function ƒ2(x) intersects with the activation function ƒ(x) at the initial values and the end values of each of the input ranges.

In the present embodiment, the first N bits value in the input value may be used as the index. For example, if the input value is 0001.1010_1100_0011₂, then the bit value of the first 5 bits may be obtained as 0001.1₂ (i.e., 1.5 in the decimal system), which namely corresponds to the input range of 1.5≤x<2 in FIG. 5, and the corresponding linear function is obtained as v₃ x+c₃. As another example, if the input value is 0010.1010_1100_0011₂, then the bit value of the first 4 bits may be obtained as 0010₂ (i.e., 2 in the decimal system), which namely corresponds to the input range of 2≤x<3 in FIG. 5, and the corresponding linear function is obtained as v₄*x+c₄.

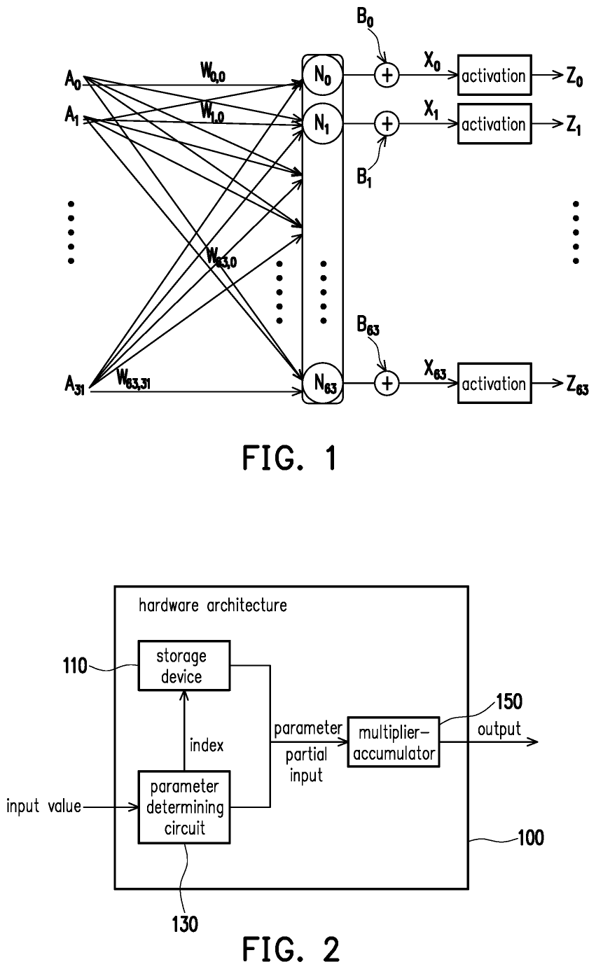

Next, the multiplier-accumulator 150 calculates an output value of the activation function by feeding a part of the bits value of the input value into the determined linear function (step S330). Specifically, step S310 may determine the linear function and the weight and bias therein. The parameter determining circuit 130 may input the input value, the weight, and the bias to the multiplier-accumulator 150, and the multiplier-accumulator 150 will calculate a product of the input value and the weight and use a sum of the product and the bias as the output value. Referring to the basic operating architecture of FIG. 1, if the multiplier-accumulator 150 can only process one single input and one single output, then the hardware architecture 100 of the present embodiment of the disclosure can implement one single activation function operation. In addition, if more multiplier-accumulators 150 (which can only process one single input and one single output) which can simultaneously process multiple inputs and multiple outputs are provided in the hardware architecture 100, all activation function operations of a neural network can be implemented.

It is noted that, to avoid an excessively low accuracy caused by the output result of function approximation, a multiplier-accumulator with a high number of input bits is adopted in the related art, which however increases the hardware cost. In an embodiment of the disclosure, the parameter determining circuit 130 uses a result of subtracting the initial value of the input range corresponding to the index from the input value as a new input value, and the multiplier-accumulator 150 feeds the new input value into the determined linear function. Specifically, taking the linear function of ƒ1(x)=w₁*x+b₁ of FIG. 4 as an example:

$$\begin{matrix}f 1 ( x ) = {w}_{1} * x - {w}_{1} * {x}_{1} + {w}_{1} * {x}_{1} + {b}_{1} \\ = {w}_{1} * ( x - {x}_{1} ) + ( {w}_{1} * {x}_{1} + {b}_{1} ) \\ = {w}_{1} * ( x - {x}_{1} ) + f 1 ( {x}_{1} )\end{matrix} \qquad ( 5 )$$

In other words, the difference between the input value and the initial value of the belonged input range may be used as the new input value, and the bias is the output value (this value may be recorded in the look-up table in advance) obtained by feeding the initial value of the belonged input range into the piece of linear function ƒ1( ) or the activation function ƒ( ). Thereby, the number of bits of the multiplier-accumulator 150 can be reduced.

In an embodiment, since the parameter determining circuit 130 only needs to use the difference between the input value and the initial value of the belonged input range as the new input value, if the initial value of the input range is associated with the first few bits value in the input value, then the parameter determining circuit 130 may use the first N bits value in the input value as the index (where N is a positive integer greater than or equal to 1 and the index corresponds to the initial value one of the input ranges) and use the last M bits value in the input value as the new input value. The sum of M and N is the total number of bits of the input value. Therefore, it is not required to adopt a multiplier-accumulator with a number of input bits equal to the total number of bits of the input value as the multiplier-accumulator 150, and the hardware architecture 100 of the present embodiment of the disclosure may adopt a multiplier-accumulator with a number of input bits smaller than the total number of bits of the input value.

Taking FIG. 5 as an example, assuming that the input value has 16 bits, a 16-bit multiplier/multiplier-accumulator may be adopted in the related art, but the present embodiment of the disclosure only needs to adopt a 12-bit multiplier/multiplier-accumulator. For example, if the input value is 0001.1010_1100_0011₂, then the bits value (i.e., 0001.1₂) of the first 5 bits are taken as the index, and the linear function may be obtained as ƒ2(x)=v₃*(x−1.5)+ƒ2(1.5). The value of x−1.5 is 0.0010_1100_0011₂. The parameter determining circuit 130 may use the last 11 (M=11) bits value in the input value as the new input value. As another example, if the input value is 0010.1010_1100_0011₂, then the value (i.e., 0010₂) of the first 4 bits are taken as the index, and the linear function may be obtained as ƒ2(x)=v₄*(x−2)+ƒ2(2). The value of x−2 is 0.1010_1100_0011₂. The parameter determining circuit 130 may use the last 12 (M=12) bits value in the input value as the new input value.

It is noted that, according to different design requirements, the number of the linear functions used to approximate the activation function is associated with the maximum error of comparing the output value with the output value obtained by feeding the input value into the activation function. To reduce the maximum error (i.e., to improve the accuracy of approximation), it is a means to increase the number of the input ranges (corresponding to the number of the linear functions), but doing so would increase the complexity. To strike a balance between accuracy (or maximum error) and complexity, the number of the input ranges is crucial or even affects the number of input bits required for the multiplier.

In addition, the activation functions tanh and sigmoid have a mutually convertible characteristic (sigmoid(x)=tanh(x/2)/2+0.5 . . . (6)), and the parameter determining circuit 130 may also obtain the output value of the sigmoid function by using a piecewise linear function which approximates tanh.

Taking FIG. 5 as an example, if the input value is 0101.0101_1000_01102, x/2 is 0010.10101_1000_011₂, then the value (i.e., 0010₂) of the first 4 bits are taken as the index, and the linear function may be obtained as ƒ2(x/2)=v₄*(x/2−2)+ƒ2(2). The value of x/2−2 is 0.1010_1100_0011₂. The parameter determining circuit 130 may use the last 12 (M=12) bits value in the input value as the new input value. Next, the multiplier-accumulator 150 may obtain tanh(x/2), and may obtain the output value of the sigmoid(x) function by using Formula (6).

It is noted that the input ranges used in the piecewise linear functions ƒ1(x) and ƒ2(x) and the contents of the linear functions in the foregoing embodiment have only been described as an example. In other embodiments, the contents thereof may be changed, and the present embodiment of the disclosure is not limited thereto.

In summary of the above, the hardware architecture and the processing method thereof for an activation function in a neural network are depicted in the embodiments of the disclosure. The input ranges of the piecewise linear function which approximates the activation function are limited, so that the range size of the input ranges is associated with the input value represented in the binary system (in the embodiments of the disclosure, the range size is limited to the exponentiation of base-2). Therefore, it is not required to perform multi-range comparison, but the corresponding linear function can be obtained by directly using the part of bits value of the input value as the index. In addition, the embodiments of the disclosure change the bias of each piece of linear function and redefines the input value of the linear function to thereby reduce the number of input bits of the multiplier-accumulator and further achieve the objectives of low costs and low power consumption.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hardware architecture for an activation function in a neural network, the hardware architecture comprising:
a storage device, recording a look-up table, wherein the look-up table is a corresponding relation among a plurality of input ranges and a plurality of linear functions, the look-up table stores slopes and biases of the linear functions, a difference between an initial value and an end value of the input range of each of the linear functions is an exponentiation of base-2, and the linear functions form a piecewise linear function to approximate the activation function for the neural network;
a parameter determining circuit, coupled to the storage device, and using at least one bit value in an input value of the activation function as an index to query the look-up table, to determine a corresponding linear function, wherein the index is an initial value of one of the input ranges; and
a multiplier-accumulator, coupled to the parameter determining circuit, and calculating an output value of the determined linear function by feeding the input value.

2. The hardware architecture for an activation function in a neural network according to claim 1, wherein a number of input bits of the multiplier-accumulator is associated with a number of bits of the input value and a number of the linear functions, and the number of the linear functions used to approximate the activation function is associated with a maximum error of comparing the output value with the output value obtained by feeding the input value into the activation function, wherein the index comprises first N bits value in the input value, and N is a positive integer greater than or equal to 1 and is associated with the initial values of the input ranges.

3. The hardware architecture for an activation function in a neural network according to claim 1, wherein the parameter determining circuit uses a result of subtracting an initial value of one of the input ranges corresponding to the index from the input value as a new input value, and the multiplier-accumulator feeds the new input value into the determined linear function.

4. The hardware architecture for an activation function in a neural network according to claim 3, wherein the parameter determining circuit uses first N bits value in the input value as the index, wherein N is a positive integer greater than or equal to 1 and the index corresponds to an initial value of one of the input ranges, and the parameter determining circuit uses last M bits value in the input value as the new input value, wherein a sum of M and N is a total number of bits of the input value.

5. The hardware architecture for an activation function in a neural network according to claim 1, wherein the bias of the linear function stored in the look-up table in the storage device is a value obtained by feeding the initial value of the input range into the activation function.

6. A processing method for an activation function in a neural network, the processing method comprising:
providing a look-up table, wherein the look-up table is a corresponding relation among multiple input ranges and multiple linear functions, the look-up table stores slopes and biases of the linear functions, a difference between an initial value and an end value of the input range of each of the linear functions is an exponentiation of base-2, and the linear functions form a piecewise linear function to approximate the activation function for the neural network;
using at least one bit value in an input value of the activation function as an index to query the look-up table, to determine the corresponding linear function, wherein the index is an initial value of one of the input ranges; and
calculating an output value of the determined linear function by feeding the input value.

7. The processing method for an activation function in a neural network according to claim 6, wherein a number of the linear functions used to approximate the activation function is associated with a maximum error of comparing the output value with the output value obtained by feeding the input value into the activation function, wherein the index comprises first N bits value in the input value, and N is a positive integer greater than or equal to 1 and is associated with the initial values of the input ranges.

8. The processing method for an activation function in a neural network according to claim 6, wherein the step of calculating the output value of the determined linear function by feeding the input value comprises:
using a result of subtracting an initial value of one of the input ranges corresponding to the index from the input value as a new input value; and
feeding the new input value into the determined linear function.

9. The processing method for an activation function in a neural network according to claim 8, wherein the step of using the result of subtracting the initial value of one of the input ranges corresponding to the index from the input value as the new input value comprises:
using first N bits value in the input value as the index, wherein N is a positive integer greater than or equal to 1 and the index corresponds to an initial value of one of the input ranges; and
using last M bits value in the input value as the new input value, wherein a sum of M and N is a total number of bits of the input value.

10. The processing method for an activation function in a neural network according to claim 6, wherein the step of querying the look-up table to determine the corresponding linear function comprises:
associating the index with an initial value of the input range of one of the linear functions, wherein the index is used to access the slope and the bias of the linear function in the look-up table, and the bias is a value obtained by feeding the initial value of the input range into the activation function.
